(19) United States
(12) Patent Application Publication
(10) Pub. No.: US 2022/0201976 A1
(43) Pub. Date: Jun. 30, 2022

(54) TICK CONTROL DEVICE HAVING ORAL DETERRENT MATERIAL

(71) Applicant: Thermacell Repellents, Inc., Bedford, MA (US)

(72) Inventors: John Hainze, Seattle, WA (US); Lawrence J. Feller, Pen Argyl, PA (US); Nicholas Bolz, Victoria (CA)

(73) Assignee: Thermacell Repellents, Inc., Bedford, MA (US)

(21) Appl. No.: 17/137,748

(22) Filed: Dec. 30, 2020

(51) Int. Cl. A01K 13/00; A01M 29/00; A01K 1/015

(52) U.S. Cl. CPC A01K 13/003; A01K 1/015; A01M 29/00

(57) ABSTRACT

A tick control tube includes a carrier medium and a treated bedding material. The treated bedding material is impregnated with an acaricide and an oral deterrent. In one aspect of the tick control tube, the carrier medium is a cardboard tube and the bedding material is a fibrous cotton, the acaricide is permethrin, and the oral deterrent is denatonium benzoate.

### CROSS-REFERENCE TO RELATED APPLICATIONS

none

### BACKGROUND OF THE INVENTION

This invention relates in general to tick control devices. More particularly, this invention relates to tick control tubes having a rodent bedding medium impregnated with an oral deterrent material to prevent oral contact, particularly by children.

Cases of tick-borne disease have increased significantly over the past decade in the North America and Europe. Lyme disease is the most commonly diagnosed tick-borne disease with an estimated 329,000 annual cases in humans, and likely many more in horses and dogs. The pathogen that causes Lyme disease is vectored by the blacklegged tick (Ixodes scapularis Say). While a single comprehensive tick control method has not been developed, tick control strategies using host-targeted methods could be used as part of an integrated pest management plan.

Rodents in the eastern North America, in particular the white-footed mouse (Peromyscus leucopus Rafinesque), are major reservoirs for Borrelia burgdorferi, the causative agent of Lyme disease. In Europe, important Lyme disease reservoir rodent species include mice in the genus Apodemus and voles in the genus Myodes. While many tick control strategies are impractical for large scale use, or may significantly affect the environment (i.e., broadcast pesticidal sprays or landscape alterations), tick tubes are a host-targeted alternative to more ecologically invasive tick control methods. Tick tubes are biodegradable cardboard tubes containing acaricide treated material. When placed in rodent habitat, the material may be used by tick hosts as nesting material. Contact with the acaricide may not only kill immature I. scapularis, reducing tick numbers, but may also reduce the risk of pathogen transmission by ticks to naïve mouse reservoirs.

Early studies demonstrated the efficacy of tick tubes in reducing ectoparasites on mice. However, other studies have found decreases in tick parasitism on mice but not in questing tick numbers. Many of these studies were conducted over large residential areas and often with tick tube application limited to one or two deployments. Variability in tick tube results may be due to differences in use of tick tube material by wildlife. Studies suggest that material use by rodents may be dependent on species. In species that are known to use these materials, the individual animals must accept the material for use in order for the devices to be effective. Tick tube material is likely carried by small mammals orally and the taste of adjuvants in the material may influence acceptability, particularly among different rodent species. Additives to prevent ingestion of material have not been previously investigated for wildlife acceptance.

In order for tick tubes to be effective, the bedding material dosed with an oral deterrent must be carried by the target rodents, which is typically done orally, back to their nesting sites. Since the nesting material may be carried for a substantial period of time, the exposure to an oral deterrent is more prolonged than would be associated with baited foodstuffs or deterrents added to prevent child ingestion. With the prolonged exposure to potential oral deterrent chemicals, there is concern that rodents will react to these deterrent chemicals and not use the bedding materials. Such a result would render the acaricide-impregnated material useless for its intended purpose, thus rendering the material unsuitable for use as bedding material by the mice. Thus, there exists a need to provide a bedding material with an acaricide material that is accepted by rodents but distasteful to small children. There is also the need to provide a dosing of an oral deterrent that is consistently applied throughout the bedding material and that the application process does not interfere with the application of the acaricide.

### SUMMARY OF THE INVENTION

This invention relates in general to tick control device. More particularly, this invention relates to tick control tubes having a rodent bedding medium impregnated with an oral deterrent material to prevent oral contact, particularly by children.

In one embodiment, a tick control tube according to the invention includes an outer carrier member and a treated bedding material. In one aspect of the invention, the outer carrier member is configured as a cardboard tube. The treated bedding material is impregnated with an acaricide and an oral deterrent. In one aspect of the invention, the bedding material is a fibrous material and may be at least in part a fibrous natural material or a fibrous polymer material having a consistency or appearance similar to medical or cosmetic cotton balls. The fibrous material may be cotton, cotton-based, wood fiber, hemp fiber, paper products, wool, wool-based, polyester or another polymer-based material comprising entangled filaments of the material. In one aspect of the invention, the acaricide is permethrin and the oral deterrent is a compound of denatonium, such as denatonium benzoate, denatonium saccharide, or denatoium chloride. The bedding material may be treated with a solution of the acaricide and oral deterrent and a volatile carrier medium, such as alcohol.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a schematic illustration of a tick control tube according to the invention.

FIG. 2 is a chart of treated and untreated (control) bedding material removed by wildlife over a 4 week period.

FIG. 3 is a table showing statistical comparison of ticks found on white-footed mice before and after deployment of tick tube samples.

### DETAILED DESCRIPTION OF THE PREFERRED EMBODIMENT

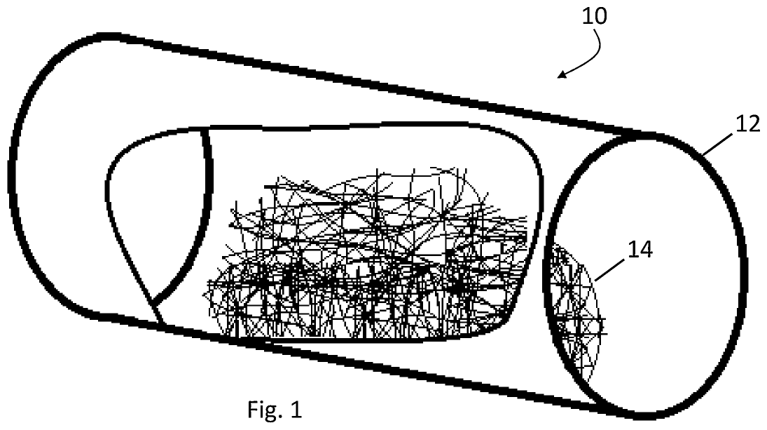

Referring now to the drawings, there is illustrated in FIG. 1 a tick control tube, shown generally at 10. The tick control tube 10 includes a carrier member 12 and a bedding material 14. In one embodiment, the carrier member is configured as a cardboard tube. The bedding material 14 is a treated bedding material that is impregnated with an acaricide and an oral deterrent. In one aspect of the invention, the bedding material is a fibrous material and may be at least in part a fibrous natural material or a fibrous polymer material having a consistency or appearance similar to medical or cosmetic cotton balls. The fibrous material may be cotton, cotton-based, wool, wool-based, polyester or another polymer-based material comprising entangled filaments of the material. The bedding material 14 is treated with permethrin as an example of a suitable acaricide. Other examples of suitable acaricides include, but are not limited to, carbaryl, bifenthrin, cyfluthrin, permethrin, nootkatone, and fipronil. The bedding material 14 is also treated with the oral deterrent configured as a compound of denatonium, such as denatonium benzoate (known as Bitrex®, registered trademark of Johnson Matthey Public Limited Company, United Kingdom), denatonium saccharide, or denatonium chloride. The bedding material may be treated with a solution of the acaricide and oral deterrent and a volatile carrier medium, such as alcohol (for example methyl alcohol, ethyl alcohol, isopropyl alcohol). In one embodiment, during manufacture the acaricide and oral deterrent are mixed with isopropanol to form a solution. The bedding material is soaked in the solution and heated to drive off the isopropanol.

The concentration of acaricide, configured as permethrin, and oral deterrent, configured as denatonium benzoate, may be higher in a dosing solution than may result on the bedding material after processing. The remaining concentration of acaricide remaining on the bedding material is in a range of about 1% to about 15% and may further be in arrange of about 5% to about 10%, and in a further range of about 7% to about 8%. The remaining concentration of oral deterrent may be in a range of about 0.00005% to about 0.0002%, about 0.0001% to about 0.010% and may further be in arrange of about 0.0005% to about 0.005%, and in a further range of about 0.0008% to about 0.0012% and may depend on treatment locality and target rodent species. Once saturated with the dosing solution, the treated bedding material is dried, fluffed or expanded, and separated into amounts for insertion into the carrier members. In one embodiment, the treated bedding material fills approximately two-thirds of the volume of the carrier member. In one aspect of the invention, the treated bedding material is configured as a cotton-based material approximately 3.5 grams in weight, and the carrier member is a cardboard tube approximately 145 mm long, approximately 40 mm diameter and having approximately 1.8 mm wall thickness. The cardboard may be generally untreated or coated with a water repelling agent such as wax.

In order to determine the efficacy of denatonium benzoate-treated bedding material, Applicant commissioned researchers at the Pennsylvania State University, Department of Entomology to conduct a short, relatively controlled field study on the efficacy of Tick Control Tubes in two formulations, permethrin and permethrin with a bittering agent added to discourage animal ingestion, for use by wildlife and tick reductions on P. leucopus. Test sites were located in the Pennsylvania State Game Lands in Centre County, Pa., USA with a mixed hardwood forest dominated by ridgetop vegetation. The site was also characterized by soils with limited drainage and a historical fire regime that is maintained with prescription burns. A study of the acceptance of denatonium benzoate-treated bedding material was also conducted in Europe because the rodent species harboring ticks that transmit Lyme disease differ from those in North America.

### Tick Control Tubes and Treatments in North American Test

Tick Control Tubes (also referred to as tick tubes) were separated into three treatment groups where the material in the tick tubes were treated with either permethrin (permethrin), permethrin and an added bittering agent (permethrin+), or water (control). The material was provided with approximately 7.5% permethrin and approximately 0.001% denatonium benzoate.

Three 100 m transects, 5 to 10 m into the forested edge and parallel to rights-of-way or gravel roads, were identified for each treatment. Ten tick tubes were deployed at 10 m intervals along each transect in suitable rodent habitat, usually under wooded or brushy areas and along trees and logs. A total of 30 tubes from each treatment group were tested. Each transect was at least 1 ha from another transect to account for P. leucopus home range sizes of ˜0.1 ha. All tick tubes were staked into the ground with utility flags to prevent movement by wildlife or weather events.

The material in each tick tube was weighed prior to deployment in mid-August 2019. Post-weighting, water was added to control material to match the weight of the treatments. After 4 weeks, the tick tubes were recovered from the field and the remaining material, if any, was dried in an oven at approximately 60° C. for 24 hours. Any remaining material was weighed to determine material use.

### Tick Parasitism on Peromyscus Spp.

Peromyscus spp. trapping was conducted in late July prior to tick tube placement and one-night immediately following tick tube removal in September. A single trap night was conducted due to high rates of recaptures in this area. Although both Peromyscus leucopus and P. maniculatus occur in Pennsylvania, the study sites were dominated by P. leucopus as determined by tail length/body length ratio, hind foot length, and tail coloration. Peromyscus leucopus were trapped using perforated Sherman traps (LFAHD folding trap, 7.62×8.89×22.86 cm, Sherman Trap Company, Tallahassee, Fla.) baited with peanut butter, oats, sunflower seeds, and apples. Cotton balls were provided for protection, warmth, and nesting material. Traps were placed in the late afternoon and processed the following morning. Within each treatment transect, ten Sherman traps were placed at the location of the tick tubes, and five additional traps were placed in suitable rodent habitat as above for a total of 15 traps per transect. Capture success at this site ranged from 10 to 25% so the total trap number deployed was chosen to provide enough captures for evaluation and on availability of personnel to process traps.

Upon capture, P. leucopus were anesthetized with isoflurane by the bell jar method. Ticks were removed with fine forceps, counted, and identified to species and life stage by morphological characteristics. Once recovered, mice were released at the location of their capture. Non-target captures were released at the point of capture.

### Statistical Analysis

Material loss data were transformed with cube root transformation to meet assumptions of normality. Tick tube material loss was pooled by treatment. Material loss among treatments was analyzed by Analysis of Variance (ANOVA). Means were separated with Tukey's HSD test.

Tick presence on trapped P. leucopus was pooled by treatment and analyzed by a full-factorial ANOVA with trapping date (pre-tick tube deployment and post-tick tube deployment) and treatment as independent variables and number of removed ticks as the dependent variable. Changes in mean numbers of ticks removed from pre-deployment to post-deployment among treatments were analyzed by t-test.

### Results

From all the treatments, 99.7% had some material loss. Nearly half (n=14) of the 30 tubes from the permethrin treatment were empty after 4 weeks and 67.2% of the cumulative material was removed. In the permethrin+treatment, ⅓ (n=30) of the tubes were empty and 47.7% of the total material was removed. There were 3 empty control tubes and 30.1% of the material was removed over the 4 weeks (data not shown). Three control tick tubes were not recovered from the field, likely due to interference with other wildlife or weather events.

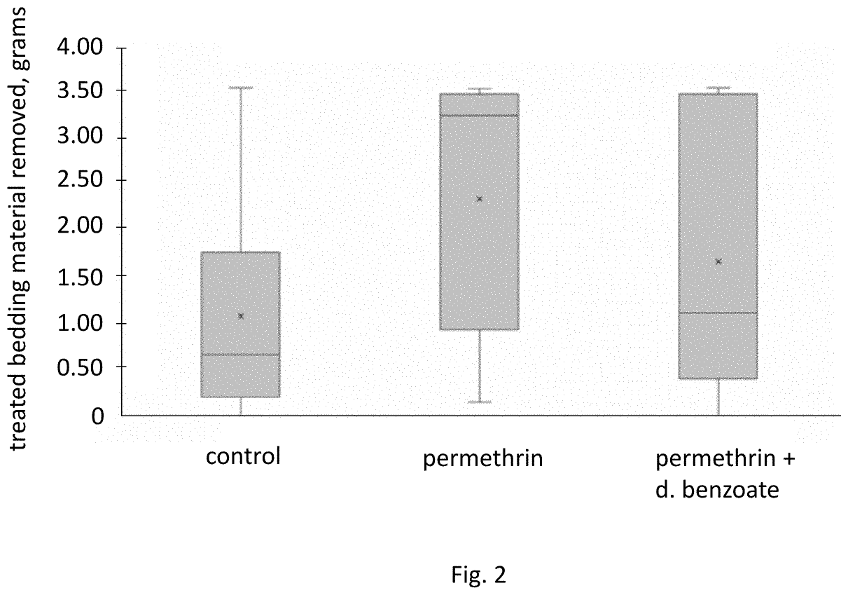

Material loss was different among treatments (F=7.36, DF=2,84, P=0.0011). The permethrin treatment had over twice as much material loss as the control (mean+SD, 2.35+1.31 and 1.01+1.18, respectively), and 40.7% greater loss than the permethrin+(1.67+1.41), but permethrin and permethrin+material loss and the permethrin+ and control were not statistically distinct (FIG. 2).

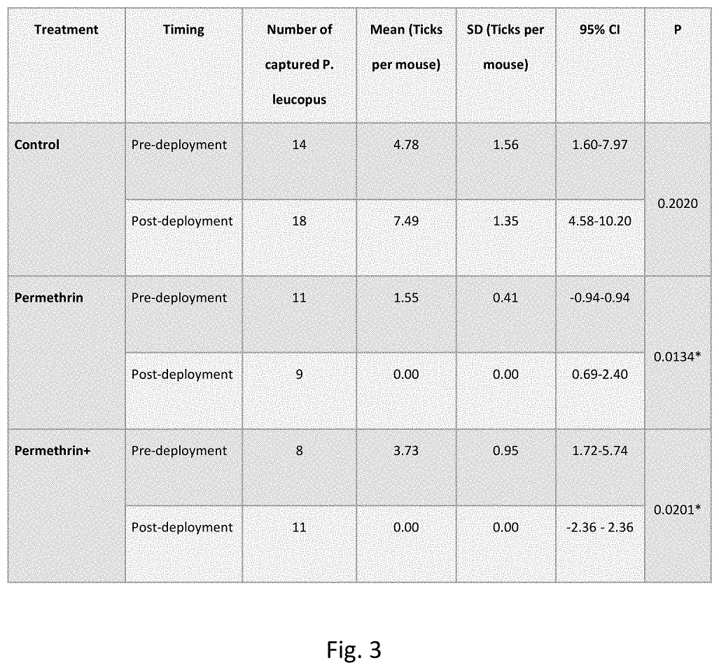

All ticks recovered were immature blacklegged ticks (Ixodes scapularis). Trapping date (pre-deployment or post-deployment) was not significant (F=0.70, DF=1,1, p=0.418). Treatment was significant (F=10.83, DF=2,2, P<0.0001) as was the interaction of date and treatment (F=3.41, DF=2,2, P=0.0390). No ticks were removed from P. leucopus trapped post-deployment in either the permethrin or permethrin+transects (FIG. 3). In both cases, this was significantly different from tick numbers removed from P. leucopus trapped pre-deployment (permethrin: t=2.55, DF=18, P=0.0201, permethrin+: t=2.99, DF=10, P=0.0134) (FIG. 2). There was no difference in the number of ticks removed from P. leucopus trapped pre- or post-deployment in the control plots (t=−1.30, DF=29, P=0.2020).

### Discussion

Tick tubes are a tool to reduce tick numbers on white-footed mice, an important reservoir of Borrelia burgdorferi. While other studies evaluating tick tubes for tick reductions reported mixed results using tick tubes in residential areas (Daniels et al. 1991, Deblinger and Rimmer 1991, Stafford 1991, 1992, Jordan and Shultze 2019), in this study I. scapularis were not recovered from P. leucopus captured in transects with treated tick tubes in a hardwood forest setting. In addition, both treatments were readily used by wildlife. These results suggest that tick tubes can be an effective tool for managing ticks on P. leucopus but additional variables should be considered to maximize efficacy.

There were no differences between the permethrin and the permethrin with the bittering agent (permethrin+d. benzoate) on material use from the tick tubes. This suggests a tolerance to these additives by wildlife using the material. The target hosts for tick tube use are primarily Peromyscus spp. mice as they are important reservoir hosts for B. burgdorferi, but a limitation of assessing tick tube use by weight is whether P. leucopus, the dominant mouse species at the research site, was the primary user of the material provided in the tick tubes. Many other native wildlife hosts may use nesting material provided in the tick tubes including squirrels, chipmunks, rabbits, and voles, or tubes may be handled, moved, and/or removed by racoons, bear, porcupine, or other larger wildlife. However, during the current study 800 trail cameras were placed at tick tubes to record video of wildlife activity. While camera data was not presented due to vegetation and feedback interference in many of the deployed cameras, observationally Peromyscus spp. were the primary user of the tick tubes.

Tick tube material use by wildlife may not be consistent over time. Material use in the tick tubes was not homogenous among treatments and there were many tubes that were completely emptied or retained much of the material. Some of the tick tubes placed in this study were empty after two weeks. It is possible that the entirety of the tick tube material could be removed in one evening which would affect efficacy over the long-term. Habitat placement of tick tubes appears to be an influential factor prior to deployment. These inconsistencies in wildlife use may have contributed to the failure of previous studies with few applications of tick tubes to demonstrate sufficient tick control. It is possible that more frequent applications or increased tube densities are needed depending on local wildlife abundance and tick tube use.

Previous studies have demonstrated differences in tick tube use and suggested that the use of bedding material may vary temporally which may affect efficacy. Alternative and abundant naturally-occurring nesting material earlier in the year may compete with provided tick tube material. In addition, breeding season or winter preparations may influence how readily tick tube material is adopted and used. To increase tick tube encounters, other additives to the tick tubes, specifically odor which is used by Peromyscus spp. to select habitats may be used throughout the season or in less desirable habitats. While ticks were found on P. leucopus trapped pre-tick tube deployment, ticks were not recovered on mice post-deployment. Control sites did not demonstrate any differences in tick burdens on rodents pre- and post-trapping. This suggests that both variations of tick tubes were effective at controlling I. scapularis ticks on P. leucopus. It is notable that material use from control tubes was lower than treatment tubes.

European Study

Tick control tubes were randomly distributed along a transect through a forested area called Zeisterwoud in the province of Utrecht in The Netherlands. Two studies were conducted here consecutively. The first study involved tubes containing cotton treated with 7% permethrin and 0.001% denatonium benzoate and tubes treated with 7% permethrin only. The second study involved tubes containing cotton treated with 7% permethrin and 0.0001% denatonium benzoate and tubes treated with 7% permethrin only. Visual inspections of the tubes were conducted on a weekly basis to assess removal of cotton. At the end of the 4-week study, the total weight of cotton remaining in the tubes was determined to obtain a precise measure of cotton removed.

Results and Conclusions—Europe

In the first study, significantly less cotton was removed from the tubes containing 0.001% denatonium benzoate, a mean of 1.28 grams, than from the tubes that did not contain denatonium benzoate, a mean of 2.10 grams (T-test p=0.00475).

In the second study, there was no significant difference in cotton removal from the tubes containing 0.0001% denatonium benzoate and the tubes that did not contain denatonium benzoate (T-test p=0.60737).

It is concluded that the mice and voles in the European study were somewhat deterred from removing 0.001% denatonium benzoate-treated cotton from tick control tubes, whereas reducing the denatonium benzoate level to 0.0001% resulted in equivalent removal to cotton that was not treated with denatonium benzoate.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A tick control tube comprising:
a carrier member; and
a bedding medium impregnated with an acaricide and an oral deterrent.

2. The tick control tube of claim 1 wherein the carrier member is a cardboard tube.

3. The tick control tube of claim 1 wherein the bedding medium is a fibrous material comprising at least one of a fibrous natural material or a fibrous polymer material.

4. The tick control tube of claim 3 wherein the fibrous material is one of a cotton material, a cotton-based material, a paper material, a wood-based material, a wool material, a wool-based material, a hair material, a polyester or another polymer-based material.

5. The tick control tube of claim 4 wherein the fibrous material comprises entangled filaments.

6. The tick control tube of claim 3 wherein the acaricide is permethrin and the oral deterrent is a compound of denatonium.

7. The tick control tube of claim 6 wherein the oral deterrent is denatonium benzoate.

8. The tick control tube of claim 7 wherein the bedding medium is a cotton-based material, the permethrin is in a concentration on the bedding medium of about 7% to about 8% and the denatonium benzoate is in a concentration of about 0.0001% to about 0.010% on the bedding medium.

9. The tick control tube of claim 7 wherein the bedding medium is a cotton-based material, the permethrin is in a concentration on the bedding medium of about 7% to about 8% and the denatonium benzoate is in a concentration of about 0.00005% to about 0.0002%.

10. The tick control tube of claim 1 wherein the bedding material is impregnated with a solution of the acaricide, the oral deterrent and a volatile carrier medium, and the volatile carrier medium is removed by one of a mechanical or a thermal treatment process.

11. The tick control tube of claim 1 wherein the acaricide is one of permethrin, carbaryl, bifenthrin, cyfluthrin, permethrin, nootkatone, or fipronil.
